(19) United States
(12) Patent Application Publication
(10) Pub. No.: US 2002/0179809 A1
(43) Pub. Date: Dec. 5, 2002

(54) Freezer tray unit

(76) Inventor: Oluwafemi Ajibola Afolabi, Brampton (CA)

Correspondence Address: OLUWAFEMI AJIBOLA AFOLABI, 16 HORSHAM STREET, BRAMPTON, ON, L6X 3R4, CA

(21) Appl. No.: 09/866,627

(22) Filed: May 30, 2001

(51) Int. Cl. B41B 11/62

(52) U.S. Cl. 249/69; 249/102; 249/119

(57) ABSTRACT

A freezer tray unit that houses removable inserts with various cavity shapes. This unit can be used to make ice in an unlimited number of shapes, by simply changing the inserts. This unit is made up of several kit contents. The quantities required for one kit are the body (1), slotted rod (1), bottom tray (1), releasers (8), and inserts (8). The unit utilizes two mechanisms for ice removal. One mechanism removes ice from individual inserts. Features responsible for this mechanism are the insert guard, slotted rod, releaser, and bottom tray. Another mechanism removes ice from all the inserts simultaneously. The ice removal features utilized in this mechanism are the insert guard, ice guard, slotted rod, and releaser. The inserts can be utilized independently in refrigerators for effective space management. Also, the inserts may be utilized for making baked products in ovens.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

This invention relates to ice (or jell-O) making devices used inside freezers, more specifically, ice trays. Existing ice trays and other ice making devices in freezers have permanently-attached cavities that produce ice with a single shape. Therefore, the end user is unable to determine the shape of the resulting ice that forms.

The methods used to remove ice in most freezer trays are complicated. Some methods involve twisting, or temporarily altering the shape of the ice tray. Other methods involve the application of forces on one or more sides of the ice container, and utilizing kitchenware.

Another limitation of existing ice making devices involves freezer space shortage. The fixed size and shape is difficult to fit inside fully packed or small freezer designs.

### BRIEF SUMMARY OF THE INVENTION

This invention allows the end user to make ice pieces with one or more shapes by utilizing inserts with various pre-shaped cavities.

The invention employs two simple ice release and removal mechanisms. The individual ice pieces are removable as pairs, or in their entirety from the freezer tray unit.

Each ice-forming insert can be used individually, without the remaining kit components. This helps to effectively manage freezer space, when desired.

Inserts fabricated from high temperature resistant material are multi-functional. These inserts can be used to freeze and bake items.

### BRIEF DESCRIPTION OF THE SEVERAL VIEWS OF THE DRAWING

All the components that comprise the freezer tray kit invention have been illustrated in the accompanying drawings. FIG. 1 is a perspective view of the Body. Arrow A depicts the direction in which the slotted rod is attached to the body. Arrow B shows the slot and direction for attaching the bottom tray. Arrow C depicts the compartment for inserts.

FIG. 2 shows a perspective view of the Slotted Rod. Arrow D depicts a slot and direction of inserting the releasers, bottom end first.

FIG. 3 depicts a perspective view of the Bottom Tray.

FIG. 4 is a perspective view of the Releaser.

FIG. 5 and FIG. 6 illustrate perspective views of inserts with different cavity shapes. Arrows E and F show the slots into which the releasers are inserted, bottom end first.

The quantities required for one kit are the body (1), slotted rod (1), bottom tray (1), releasers (8), and inserts (8).

### DETAILED DESCRIPTION OF THE INVENTION

The first kit assembly step occurs in an inverted position of the body. Inserts are arranged into compartments as depicted by C in FIG. 1. Thereafter, the bottom tray slides in place, as shown in FIG. 1, depicted by B. The bottom tray supports the inserts in the upright position.

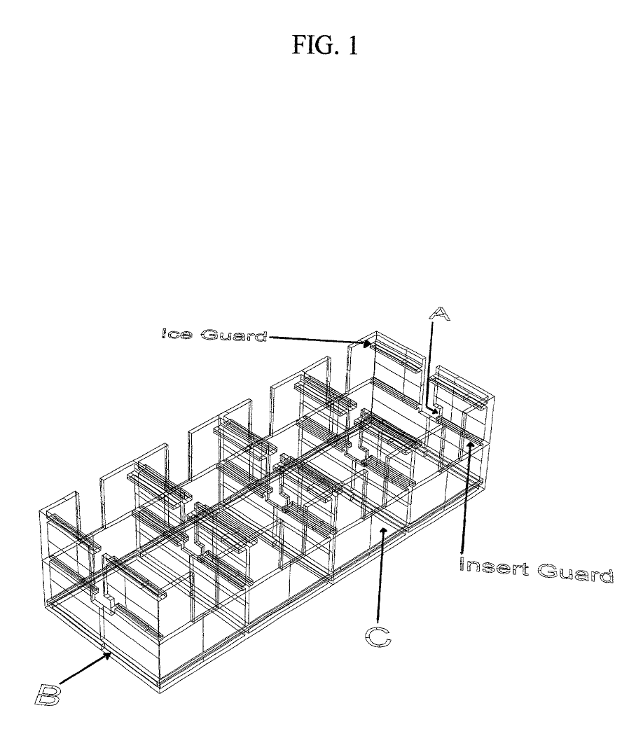

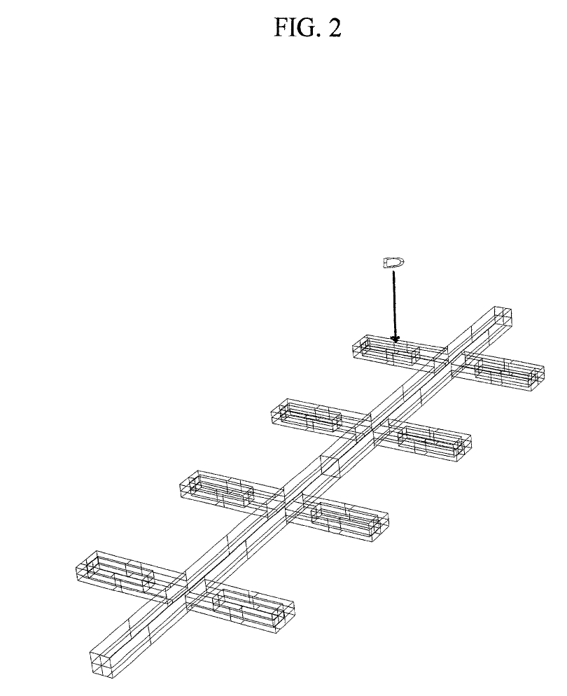

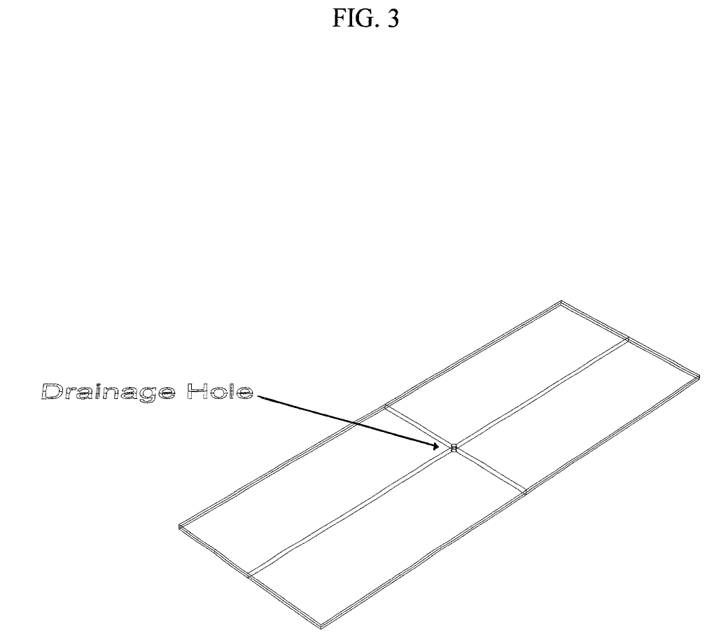

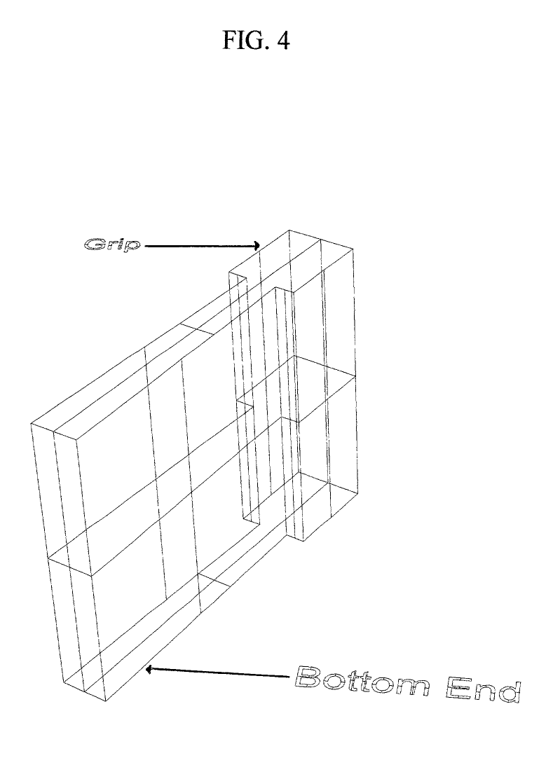

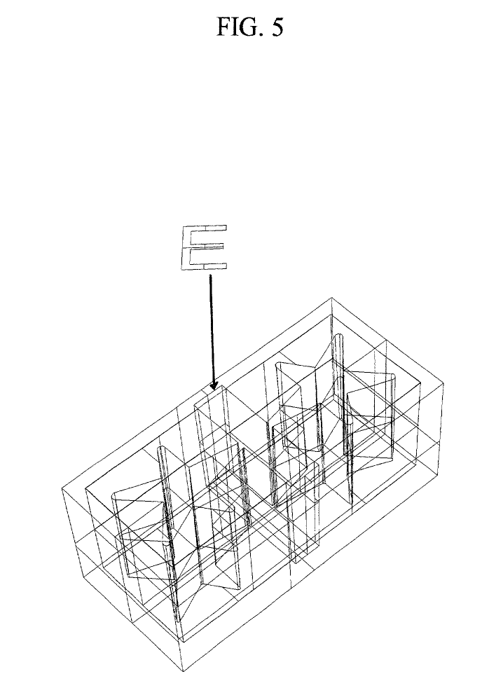

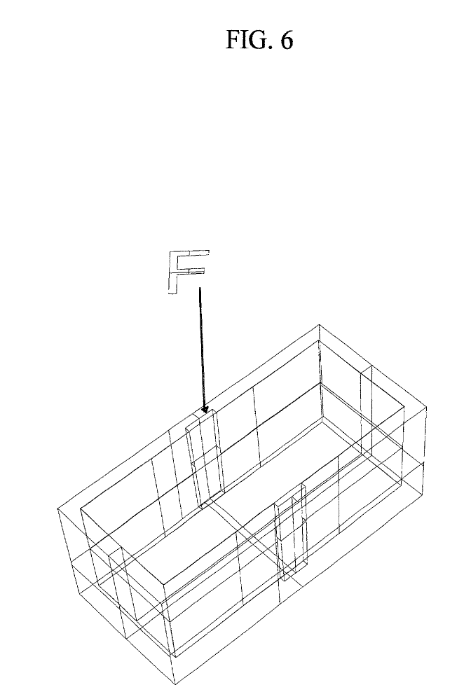

In the next step, the slotted rod is attached to the body as indicated by A in FIG. 1. Then, releasers are inserted into corresponding slots, as depicted in FIG. 2 by D, and also FIG. 5 and FIG. 6 by E and F. The releasers' grips cannot pass through the slots of the slotted rod. As a result, the grip end of each releaser sits on the slotted rod. This is the final step of the kit assembly process.

The liquid to be frozen (water or jell-O) fills the insert cavities from an upright position. The kit is then placed into a freezer to make the ice.

The frozen ice can be removed from each insert in pairs, or from all the inserts simultaneously. The mechanism of releasing ice from individual inserts (as a pair) involves pulling the corresponding grip of the releaser away from the insert. In the second mechanism that releases all the ice simultaneously, the slotted rod is moved in the reverse A direction. Each mechanism releases the ice bonding with the insert and the releasers.

The ice can be removed by inverting or tilting the body (if the slotted rod has been previously detached as in the second mechanism), or by sliding the bottom tray in the B direction to remove single inserts and loosened ice from compartments.

In the first ice release mechanism, the insert guard prevents the insert from advancing further, while the releaser is being displaced or pulled away. The vertical slant or draft of the slotted rod helps to maintain upward pressure on the ice. This results in the removal of the ice from the insert cavities, while further displacement of the insert is prevented. Any sustained bonding with the releaser is eliminated when the ice makes contact with the slotted rod, as the releaser gets advanced further.

In the second mechanism, ice is released from all inserts in a similar fashion as the first mechanism, when the slotted rod is displaced or pulled away. The function of the ice guard is to detach ice pieces from the releaser at this point.

Insert and releaser combinations can be utilized individually to effectively manage freezer space. In this case, the releaser is inserted into the insert slots depicted by E and F in FIGS. 5 and 6. Thereafter, the insert cavity is filled with liquid and placed in a freezer. The frozen ice is released by keeping the insert stationary (holding down), while displacing or pulling the releaser upwards.

I claim:

1. A device (or slotted rod) utilized for an application that allows dislodging or release of components or objects in a single vessel through slots contained on its body;
a given motion of this device will cause dislodging or release of the previously mentioned components or objects collectively in multiple vessels.

2. The use of materials containing cavities having dual functions of forming ice or Jell-O in freezers, and making baked products in ovens or heated environments.

3. A freezer tray unit that contains removable, detachable, or replaceable components (or inserts) with ice-forming cavities of various shapes.

4. A freezer tray unit comprising of a body or frame, that has no functionality by itself, but which utilizes removable, detachable, or replaceable components (or inserts) with ice-forming cavities;
these components are used primarily for making or forming one or more ice shapes.

5. A freezer tray unit with ice (or Jell-O) release and removal mechanisms comprising of a releaser, insert, insert guard, ice guard, and a slotted rod;
in the first mechanism, a pull or displacement of the releaser over a given distance forces the ice to get dislodged from the insert, because the insert guard prevents further movement of the insert in the displacement direction, while the ice motion is unrestricted,
in the next stage, the stationary slotted rod dislodges the ice from the releaser,
the ice is then removed from the compartment by sliding the bottom tray to create an exit opening.

6. The freezer tray unit of claim 5, that employs a second ice release mechanism, in which a slotted rod holding multiple releasers is used to dislodge an entire tray of ice pieces simultaneously;
a pull or displacement of the slotted rod over a given distance forces ice pieces to get dislodged from inserts, because insert guards restrict further movement of inserts in the displacement direction, while the ice motion is unrestricted,
in the next stage, ice guards dislodge the ice pieces from releasers, which fall back into ice compartment of the body and are poured out through the top opening created by the separated slotted rod.
